(19) United States
(12) Patent Application Publication
(10) Pub. No.: US 2026/0145309 A1
(43) Pub. Date: May 28, 2026

(54) TENSION BOARD LATCH

(71) Applicant: WIREMAN PTY LIMITED, MILSONS POINT (AU)

(72) Inventor: Ian LOWREY, Milsons Point (AU)

(21) Appl. No.: 19/394,107

(22) Filed: Nov. 19, 2025

(30) Foreign Application Priority Data
Nov. 25, 2024 (AU) 2024903879

(51) Int. Cl. B25B 25/00; E04H 17/02

(52) U.S. Cl. CPC B25B 25/00; E04H 17/127

(57) ABSTRACT

A tension board arrangement (1) has a pair of elongated bodies (2,3), a longitudinally extending hinge mechanism (5) releasably inter-connecting the bodies to create a longitudinally extending bight (9) therebetween which, when decreased to a predetermined degree, will maintain the arrangement on a wire mesh to be tensioned. A lever (11) is pivoted at one end to one of the bodies and movable by an external force applied adjacent to the other end of the lever in a first direction to decrease the size of the bight. A latch mechanism (20,26) is connected between the other one of the bodies and the other end of the lever to retain the bight decreased to the predetermined degree.

### FIELD OF THE INVENTION

The present invention relates to tension boards used to tension prefabricated wire netting or wire mesh.

### BACKGROUND ART

The simplest form of a prior art tension boards consists of two timber planks which are located one to either side of the mesh or netting and bolted together so as to clamp the mesh or netting between the boards. A similar prior art tension board is formed from two metal strips which again clamp the mesh or netting between the boards and which are held in place by means of apertured protrusions which extend from one board through corresponding openings in the second board. A wedge corresponding to each aperture is then driven into the aperture so as to force the second board towards the first board. Australian Innovation Patent No. 2013100301 exemplifies this prior art.

A different form of a prior art tension board is that disclosed in International Patent Application Nos WO 2020/176936 and WO2023/215934, both to the present applicant. These prior art tension boards require a multiplicity of wire grippers, in general one gripper corresponding to each line wire of the prefabricated mesh. Such wire grippers are not easily adapted to gripping netting, such as the netting used to prevent rabbits passing through a fence or used to fence in chickens, and like fowl, or horses.

A difficulty with the above-described metal tension boards held together with wedges, is that the clamping force produced by each wedge cannot be determined with accuracy and will, in general, be different from that produced by another one of the wedges. Thus, some part of the mesh or netting may slip relative to another part. In addition, the need to hit the wedges with a hammer, results in deformation not only of the wedges but also of the metal of the boards with which the wedges come into contact. Still further, the wedges are often lost or mislaid, particularly when the tension boards are transported between jobs or used in jobs where there is long grass.

In order to address the difficulties involved in using metal tensioning boards held together by wedges, and similar devices, the applicant has created a new tension board arrangement which takes the form of a pair of elongated bodies, a longitudinally extending hinge mechanism releasably inter-connecting the bodies to create a longitudinally extending bight therebetween which, when decreased to a predetermined degree, will clamp the wire mesh to be tensioned. A lever arm is pivoted at one end to one of the bodies and movable by an external force applied adjacent to the other end of the lever in a first direction to decrease the size of the bight and thereby securely clamp the wire mesh. Normally a plurality of these levers are provided.

This new tension board arrangement is disclosed in Australian Patent Applications Nos 2024901065; 2024902832 and 2024903105 all of which are unpublished as at the priority date of the present application and have been combined into International Patent Application No PCT/AU 2025/050357 which was published as International Patent Application No WO2025/217671 after the priority date of this application. The contents of all the above patent applications are hereby incorporated into the present specification for all purposes.

The testing of prototypes of the above-mentioned new tension board arrangement indicates that once the board is applied to the mesh, but before the tensioning force is applied to the tension board arrangement, the arrangement has a tendency to slip slightly relative to the mesh. This slows the work since it is necessary for the tension board to be repositioned once the initial tensioning force is applied, but before the tensioning has begun to appreciably move the mesh relative to the fence posts.

### GENESIS OF THE INVENTION

The genesis of the present invention is a desire to at least ameliorate the above-mentioned difficulty by attempting to prevent the above-mentioned slipping.

### SUMMARY OF THE INVENTION

In accordance with a first aspect of the present invention there is disclosed a tension board arrangement comprising:

a pair of elongated bodies,

a longitudinally extending hinge mechanism releasably inter-connecting the bodies to create a longitudinally extending bight therebetween which, when decreased to a predetermined degree, will maintain the arrangement on a wire mesh to be tensioned, and

a lever pivoted at one end to one of the bodies and movable by an external force applied adjacent to the other end of the lever in a first direction to decrease the size of the bight,

wherein a latch mechanism is connected between the other one of the bodies and the other end of said lever to retain said bight decreased to the predetermined degree.

Preferably, the latch takes the form of an over toggle centre mechanism.

Preferably, the latch comprises a curved recess on the other one of the bodies, and a toggle arm pivoted at one end adjacent the other end of the lever, having a curved other end able to mate with the curved recess, and having a length sufficient to hold said latch mechanism in the bight decreased position with the curved other end engaged with the curved recess.

Preferably, the curved recess comprises a spaced apart pair of curved recesses and the toggle arm comprises a dual toggle arm having two spaced apart toggle arms, the spacing between the toggle arms corresponding to the spacing between the recesses.

### BRIEF DESCRIPTION OF THE DRAWINGS

A preferred embodiment of the invention will now be described, by way of example only, with reference to the accompanying drawings in which:

FIGS. 1 - 3 reproduce FIGS. 29 -31 of the above-mentioned WO2025/217 671 and are respectively a first perspective view of the prototype tensioning arrangement, a second perspective view of the prototype tensioning arrangement, and an end perspective view of the prototype tensioning arrangement.

FIG. 4 is a first perspective view of the lower end of a tension board arrangement of a first embodiment of the present invention and incorporating a latch with dual toggle arms,

FIG. 5 is a second perspective view of the embodiment of FIG. 4,

FIG. 6 is a further perspective view of the arrangement of FIGS. 4 and 5 with the latch in an initial engagement position,

FIG. 7 is a similar perspective view to that of FIG. 6 but illustrating the latch in its final operative position

FIGS. 8 - 10 are a sequence of end views which respectively show the latch prior to its initial engagement position, in its initial engagement position, and in its final operative position,

FIGS. 11 and 12 reproduce FIGS. 9 and 10 respectively and show a dashed line interconnecting the pivot points of the lever and the dual toggle arms, and

FIG. 13 is a perspective view of the tension board arrangement of the first embodiment during the tensioning procedure.

### DETAILED DESCRIPTION

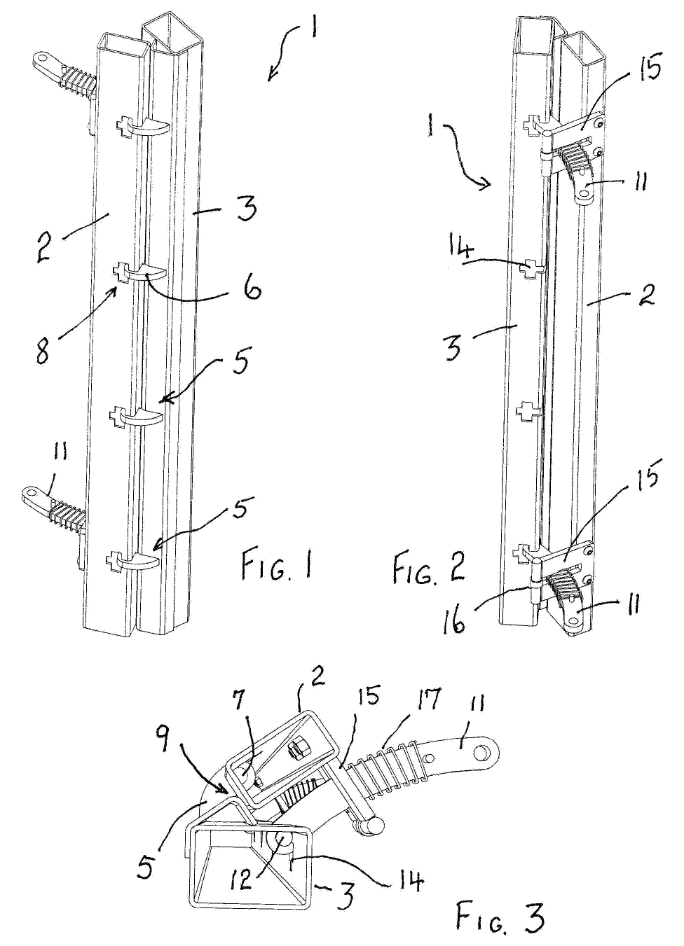

As seen in FIGS. 1-3, the prototype tensioning arrangement 1 described in the abovementioned WO2025/217 671 takes the form of a pair of elongated bodies 2, 3, and a longitudinally extending hinge mechanism 5 releasably inter-connecting the bodies 2, 3. The hinge mechanism takes the form of a plurality of arcuate lugs 6 each of which has a transverse pin 7 and a corresponding plurality of cross-shaped apertures 8 in the body 2. By inserting the transverse pins 7 into the apertures 8, the two bodies 2, 3 are releasably connected together and hinged so as to create a longitudinally extending bight 9 therebetween which, when decreased, will clamp the arrangement 1 on a wire mesh to be tensioned.

A pair of lever arms 11 are provided in order to allow the application of a tensioning force. Each lever arm 11 has a transverse arm 12 at one end. Each transverse arm 12 is able to be inserted into a corresponding one of cross shaped apertures 14 in the body 3. Each lever 11 extends through a plate 15 connected to the body 2 and having a roller 16 which is able to engage an arcuate edge of the lever 11. A spring 17 is retained on each of the levers 11. With the transverse arm 12 inserted into the corresponding aperture 14, the lever 11 is thus pivoted at one end to the body 3. Consequently, an external force applied adjacent to the other end of the lever 11 in a first direction (downwardly in FIG. 3) acts to decrease the size of the bight 9 and thereby securely clamp the wire mesh. Normally a plurality of the levers 11 are provided.

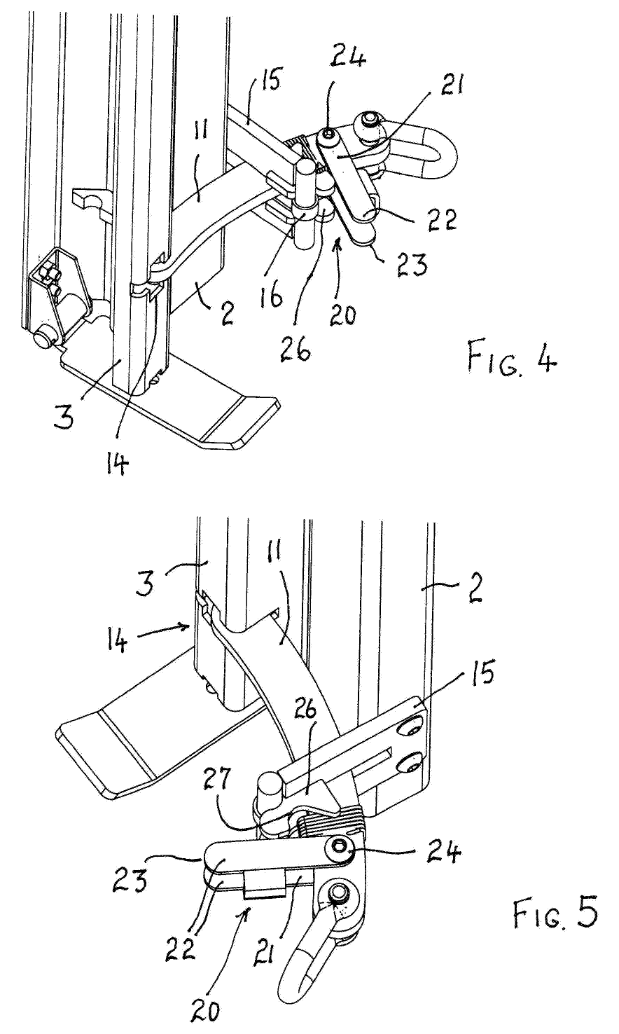

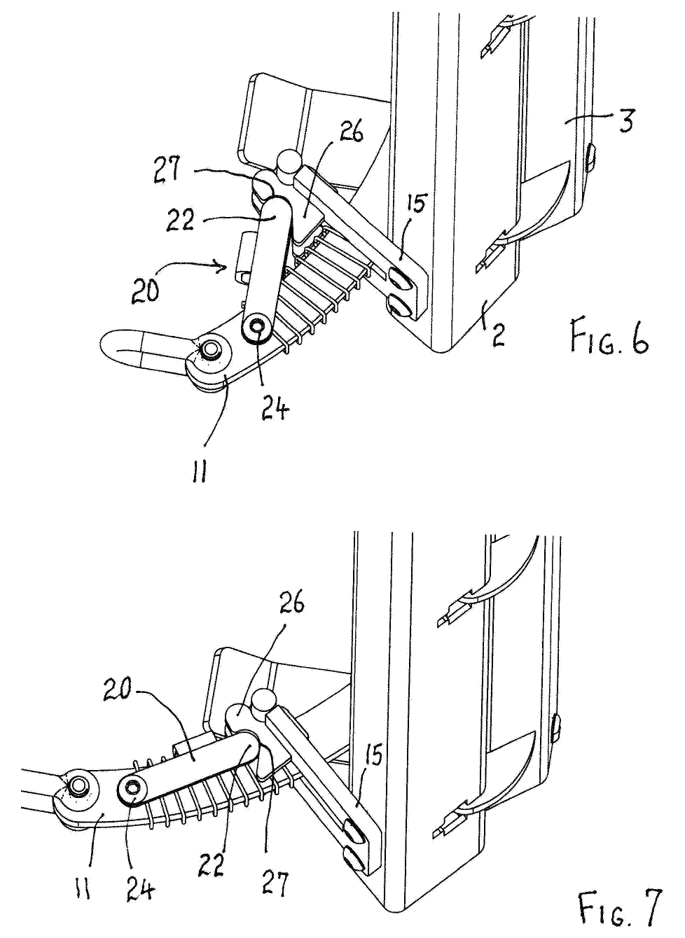

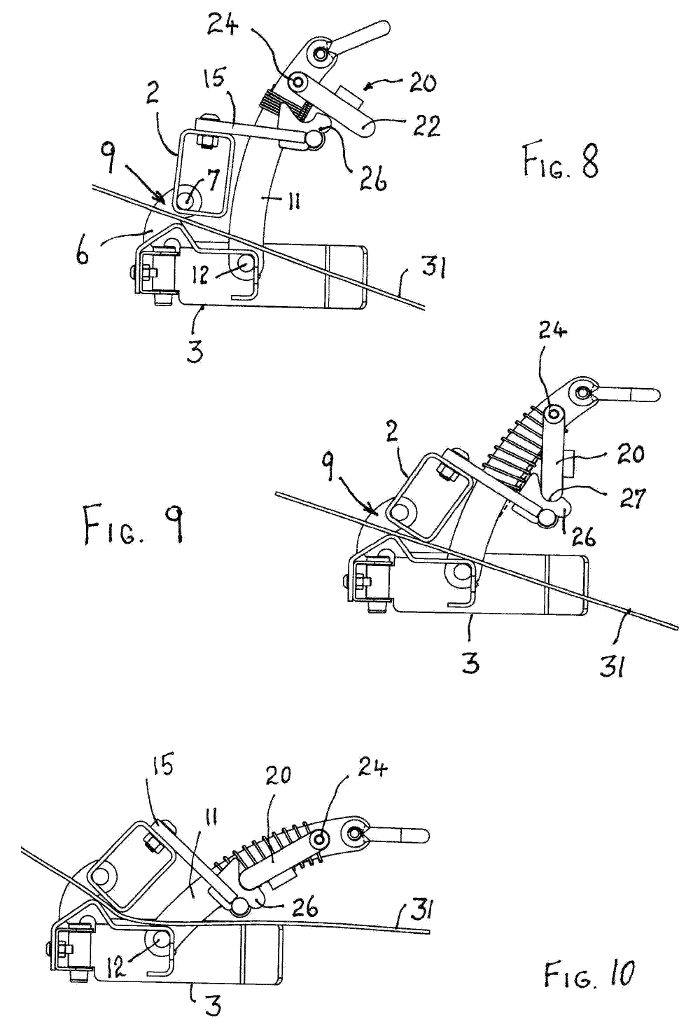

Turning now to FIGS. 4-7, in accordance with the first embodiment of the present invention, the above-mentioned arrangement is modified by the provision of dual toggle arms 20 which have one end 21 pivoted to the lever 11 by means of a bolt 24. The other end 22 of the dual toggle arms 20 are provided with a radiused curve 23, as best seen in FIG. 4.

In addition, the plate 15 is provided with a pair of spaced apart bosses 26, the distance between the bosses 26 corresponding to the distance between the arms of the dual toggle arms 20. The bosses 26 are welded to the plate 15 and each boss 26 is provided with a curved recess 27.

Turning now to FIGS. 8-10, it will be seen that a wire 31 passes through the bight 9 between the bodies 2, 3. The wire 31 is part of a mesh 32 (as seen in FIG. 13). In order to arrive at the situation illustrated in FIG. 8, the body 3 is placed on one side of the wire 31 and the lugs 6 are passed through the mesh and into the apertures 8 in the body 2 (which is located on the other side of the wire 31 (and mesh 32). This hingedly interconnects the bodies 2 and 3. Then the transverse arms 12 of the levers 11 are passed through the mesh 32 and into the cross shaped apertures 14 of the body 3. This is the position illustrated in FIG. 8 and it will be seen that the dual toggle arms 20 extend away from the lever 11 and rest on the bosses 26.

In order to reach the position illustrated in FIG. 9, the lever 1 is initially pulled to the left as seen in FIGS. 8-10 which engages the arms 20 and bosses 26. Then the lever 11 is moved to the right, thereby beginning to decrease the size of the bight 9. As this latter movement of the lever 11 takes place, the other ends 22 of the dual toggle arms 20 maintain their engagement with the curved recesses 27 of the bosses 26. This is the position illustrated in FIG. 9.

If the lever arm 11 is then pushed to the right as seen in FIG. 10, the over centre toggle mechanism provided by the dual toggle arms 20 and the curved recesses 27 comes into action so as to retain the lever arm 11 in the position illustrated in FIG. 10. In this position the bodies 2, 3 are latched relative to each other and the bight 9 is reduced so as to clamp the wires 31 of the mesh 32 between the two bodies 2, 3. In this respect the wire 31 is to some extent elastic and undergoes some elastic deformation to permit the latch to move from the position illustrated FIG. 9 into the position illustrated in FIG. 10.

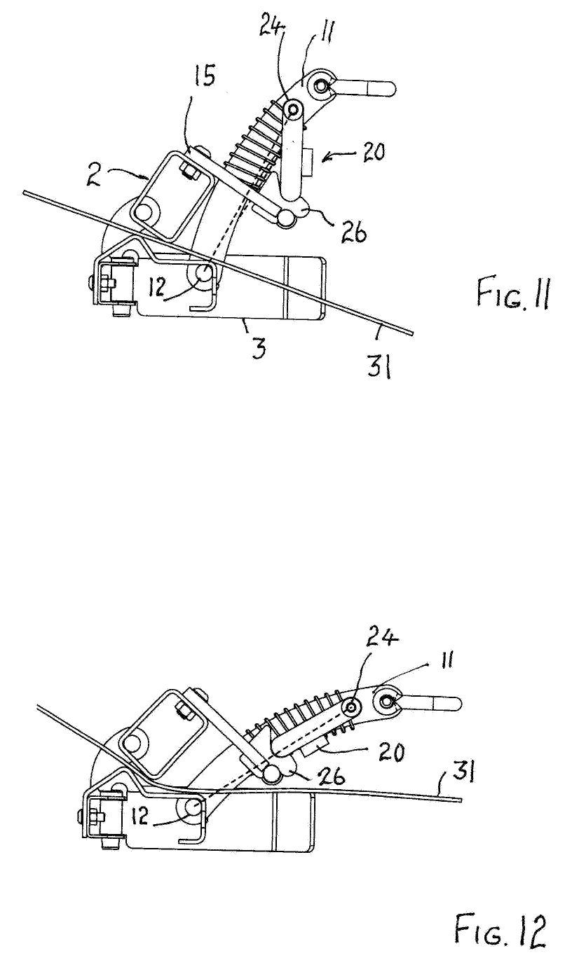

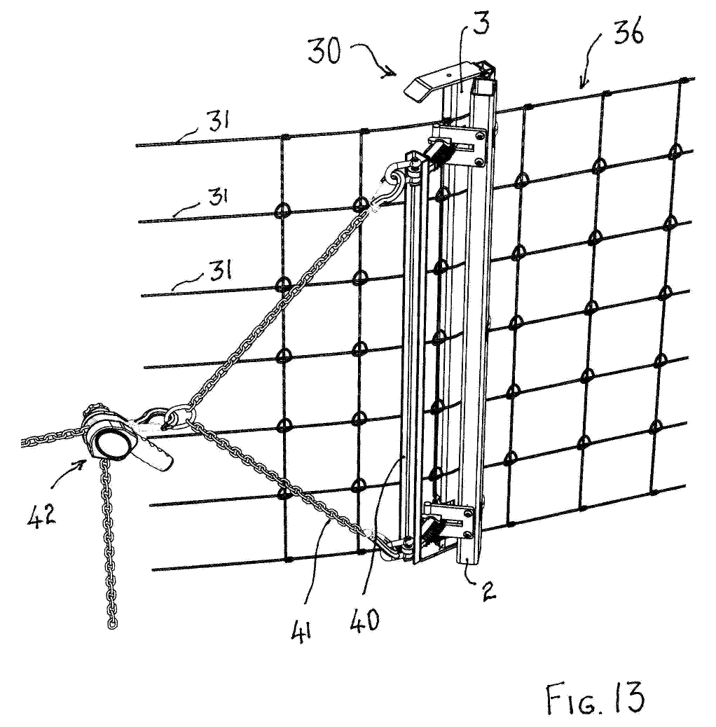

In FIGS. 11 and 12, a dashed line is drawn between the centre of the transverse arm 12 and the centre of the bolt 24. In FIG. 11, the dual toggle arm lies to the right of the dashed line. However, in FIG. 12, the dual toggle arm 20 lies just to the left of the dashed line and, in order to reach that position, must elongate the distance between the transverse arm 12 and the bolt 24 as the curved other end 22 of the dual toggle arms rotates in the curved recess 27. Thus, it will be apparent that the position illustrated in FIG. 12 represents a stable state of the over centre toggle mechanism.

In the situation illustrated in FIGS. 10 and 12, the wires 31 are securely held between the bodies 2, 3 and thus enable the modified tensioning arrangement to securely grasp the mesh 32 as seen in FIG. 13. This enables the tensioning arrangement 30 and the mesh 32 to be moved together without slipping. As seen in FIG. 13 a spreader bar 40, chain yoke 41, and winch 42 are used to tension the mesh 32. This is done by applying a force to the right as seen in FIGS. 10 and 12 (but to the left as seen in FIG. 13).

At the conclusion of the tensioning process, after the mesh 32 has been secured to an end post or strainer assembly (not illustrated), the tension supplied by the chain yoke 41 and winch 42 is removed. The lever 11 is then able to be unlatched by being moved to the left as seen in FIGS. 10 and 12, thereby returning the latch to the situation illustrated in FIG. 9 which permits disengagement of the lever 11 with the body 3.

The foregoing describes only one embodiment of the present invention and modifications, obvious to those skilled in the fencing arts, can be made thereto without departing from the scope of the present invention. For example, the features and advantages disclosed in one facet of the invention may be utilised, mutatis mutandis , in other facets of the invention. If desired, the dual toggle arms 20 can be replaced by a single toggle arm, however, the dual arrangement provides for balanced forces to be applied to the levers 11.

The term “comprising” (and its grammatical variations) as used herein is used in the inclusive sense of “including” or “having” and not in the exclusive sense of “consisting only of”.

1. A tension board arrangement comprising:
a pair of elongated bodies,
a longitudinally extending hinge mechanism releasably inter-connecting said bodies to create a longitudinally extending bight therebetween which, when decreased to a predetermined degree, will maintain said arrangement on a wire mesh to be tensioned, and
a lever pivoted at one end to one of said bodies and movable by an external force applied adjacent to the other end of said lever in a first direction to decrease the size of said bight,
wherein a latch mechanism is connected between the other one of said bodies and said other end of said lever to retain said bight decreased to said predetermined degree.

2. The tension board arrangement as defined in claim 1 wherein said latch comprises an over toggle centre mechanism.

3. The tension board arrangement as defined in claim 2 wherein said latch comprises a curved recess on said other one of said bodies, and a toggle arm pivoted at one end adjacent said other end of said lever, having a curved other end able to mate with said curved recess, and having a length sufficient to hold said latch mechanism in said bight decreased position with said curved other end engaged with said curved recess.

4. The tension board arrangement as defined in claim 3 wherein said curved recess comprises a spaced apart pair of curved recesses and said toggle arm comprises a dual toggle arm having two spaced apart toggle arms, the spacing between said toggle arms corresponding to the spacing between said recesses.

5. The tension board arrangement as defined in claim 1 and comprising a pair of said levers.

6. The tension board arrangement as defined in claim 1 wherein the or each of said levers is substantially arcuate.

7. The tension board arrangement as defined in claim 6 wherein the or each of said levers rolls over a corresponding roller.
